(19) United States
(12) Patent Application Publication
(10) Pub. No.: US 2023/0290138 A1
(43) Pub. Date: Sep. 14, 2023

(54) ANALYTIC PIPELINE FOR OBJECT IDENTIFICATION AND DISAMBIGUATION

(71) Applicant: The MITRE Corporation, McLean, VA (US)

(72) Inventors: Joseph JUBINSKI, McLean, VA (US); Ransom WINDER, McLean, VA (US); Akash TRIVEDI, McLean, VA (US); Elmer ARMIJO RIVERA, McLean, VA (US)

(73) Assignee: The MITRE Corporation, McLean, VA (US)

(21) Appl. No.: 18/119,127

(22) Filed: Mar. 8, 2023

Related U.S. Application Data
(60) Provisional application No. 63/318,224, filed on Mar. 9, 2022.
(60) Provisional application No. 63/339,660, filed on May 9, 2022.

(51) Int. Cl. G06V 10/70; G06V 10/764; G06V 10/776; G06V 10/26

(52) U.S. Cl. CPC G06V 10/87; G06V 10/764; G06V 10/776; G06V 10/26; G06V 2201/10

(57) ABSTRACT

Presented herein are systems and methods for identifying and disambiguating individual objects of interest from a data set. In one or more examples, image data can be received and processed to identify candidate images that may contain one or more objects of interest. The candidate image data can then be processed to segment potential objects of interest from the candidate images. The segmented potential objects of interest can then be processed via one or more analytics to determine whether each potential objects of interest is an object of interest, to determine an object type, and/or to disambiguate specific objects of interest.

### CROSS REFERENCE TO RELATED APPLICATIONS

This application claims the benefit of U.S. Provisional Application No. 63/318,224, filed Mar. 9, 2022, and claims the benefit of U.S. Provisional Application No. 63/339,660, filed May 9, 2022, the entire contents of each of which are hereby incorporated by reference.

### FIELD OF THE DISCLOSURE

This disclosure relates to systems and methods for identifying and disambiguating an object of interest from a data set.

### BACKGROUND OF THE DISCLOSURE

Detecting and monitoring certain objects of interest are important aspects of defense and intelligence operations. Taking for example aircraft, analysts may be particularly interested in monitoring the geographic location where a certain country has bomber aircraft located, and how many such aircraft are located there. Further, identifying and monitoring the status of aircraft, such as identifying a specific aircraft and tracking its movements or monitoring whether the aircraft is merely parked or is actively being loaded with armored vehicles, can provide vital intelligence to supplement defense readiness.

To detect and monitor objects of interest, defense and intelligence analysts often process satellite images either manually or with some form of computerized processing method. Determining whether a given image depicts objects of interest is a relatively simple task for a human. Analyzing hundreds of images, however, is a time consuming task. Rather than manually analyzing each image, computer algorithms such as machine learning classifiers or other image processing algorithms can be used to quickly assess whether the collected images contain objects of interest. Such computer algorithms can process thousands of images and automatically detect the presence of objects resembling an object of interest in a short amount of time. Computerized object detection methods and systems can consistently perform such detection, thereby saving time without sacrificing accuracy.

However, computerized processing methods require that the images collected actually depict objects of interest, meaning the satellite images must be collected from appropriate geolocations where such objects of interest actually are. Moreover, computerized object detection methods may perform less reliably when detecting objects in images that depict only a part of the object or that depict a variety of adverse environment conditions such as a low-contrast background relative to the object or weather conditions such as snow or clouds. Further, disambiguating specific objects of interest requires more than just object detection. Rather, disambiguating specific objects of interest requires first receiving image data that depicts one or more objects of interest, detecting each object of interest, determining which type of object is depicted, and finally, determining which specific object of that type is depicted. This complex computerized processing requires a large volume of training image data and sophisticated computerized methods to process that volume of data efficiently.

### SUMMARY OF THE DISCLOSURE

Presented herein are systems and methods for identifying and disambiguating individual objects of interest from a data set according to examples of the disclosure. Such objects of interest can include, for example, aircraft (such as an airplane or helicopter), cars, trucks, boats, tanks, artillery, weapons, etc. In one or more examples, image data can be received and processed to identify candidate image data that may contain one or more objects of interest. Image data may also be identified via a tip-and-cue process relying on supplemental evidence to identify candidate image data that may contain one or more objects of interest. The candidate image data can then be processed to segment potential objects of interest from the candidate images. In one or more examples, the segmented potential objects of interest can be processed via one or more analytics to determine whether each potential object of interest is an object of interest, to determine an object type, and/or to disambiguate specific objects.

In one or more examples, a method for identifying objects of interest from image data can comprise: receiving a plurality of supporting evidence from one or more evidence sources, identifying an indicator from the plurality of supporting evidence that indicates an object of interest may be located in a particular geolocation at a particular time, selecting one or more candidate images from a plurality of digital images based on the indicator, segmenting one or more potential objects of interest from the one or more selected candidate images, wherein segmenting the one or more potential objects of interest from the one or more selected candidate images comprises applying one or more segmentation analytics to the one or more selected candidate images to identify the one or more potential objects of interest, determining whether each of the one or more segmented potential objects of interest is an object of interest, determining an object type for each identified object of interest, and determining whether each identified object of interest is a specific known object of interest.

Optionally, determining whether each of the one or more segmented potential objects of interest is an object of interest comprises applying one or more object detection analytics comprising one or more object detection classifiers to the one or more selected candidate images.

Optionally, the one or more object detection analytics identify one or more environmental characteristics in the one or more selected candidate images, and determining whether each of the one or more segmented potential objects of interest is an object of interest comprises: selecting one or more scene classifiers from a plurality of scene classifiers based on the identified one or more environmental characteristics, and applying one or more scene analytics comprising the one or more selected scene classifiers to the one or more selected candidate images.

Optionally, determining the object type for each identified object of interest comprises: selecting one or more object type classifiers from a plurality of object type classifiers, and applying one or more object type analytics comprising the one or more selected object type classifiers to the one or more selected candidate images.

Optionally, the one or more object type classifiers are selected based on the results of applying the one or more object detection analytics.

Optionally, determining whether each identified object of interest is a specific known object of interest comprises: selecting one or more known object classifiers from a plurality of known object classifiers, and applying one or more known object analytics comprising the one or more selected known object classifiers to the one or more selected candidate images.

Optionally, the one or more known object classifiers are selected based on the results of applying the one or more object type analytics.

Optionally, the method comprises generating assessment data based on the indicator and embedding the assessment data as metadata in one or more selected candidate images.

Optionally, the method comprises determining one or more status indicators about the one or more identified object of interest and embedding the one or more status indicators as metadata that accompanies the one or more selected candidate images.

In one or more examples, a system for identifying objects of interest from image data, can comprise: a memory, one or more processors, and one or more programs, wherein the one or more programs are stored in the memory and configured to be executed by the one or more processors, the one or more programs when executed by the one or more processors cause the processor to: receive a plurality of supporting evidence from one or more evidence sources, identify an indicator from the plurality of supporting evidence that indicates an object of interest may be located in a particular geolocation at a particular time, select one or more candidate images from a plurality of digital images based on the indicator, segment one or more potential objects of interest from the one or more selected candidate images, wherein segmenting the one or more potential objects of interest from the one or more selected candidate images comprises applying one or more segmentation analytics to the one or more selected candidate images to identify the one or more potential objects of interest, determine whether each of the one or more segmented potential objects of interest is an object of interest, determine an object type for each identified object of interest, and determine whether each identified object of interest is a specific known object of interest.

Optionally, determining whether each of the one or more segmented potential objects of interest is an object of interest comprises applying one or more object detection analytics comprising one or more object detection classifiers to the one or more selected candidate images.

Optionally, the one or more object detection analytics identify one or more environmental characteristics in the one or more selected candidate images, and determining whether each of the one or more segmented potential objects of interest is an object of interest comprises: selecting one or more scene classifiers from a plurality of scene classifiers based on the identified one or more environmental characteristics, and applying one or more scene analytics comprising the one or more selected scene classifiers to the one or more selected candidate images.

Optionally, determining the object type for each identified object of interest comprises selecting one or more object type classifiers from a plurality of object type classifier, and applying one or more object type analytics comprising the one or more selected object type classifiers to the one or more selected candidate images.

Optionally, the one or more object type classifiers are selected based on the results of applying the one or more object detection analytics.

Optionally, determining whether each identified object of interest is a specific known object of interest comprises selecting one or more known object classifiers from a plurality of known object classifiers, and applying one or more known object analytics comprising the one or more selected known object classifiers to the one or more selected candidate images.

Optionally, the one or more known object classifiers are selected based on the results of applying the one or more object type analytics.

Optionally, the one or more programs when executed by the one or more processors cause the processor to generate assessment data based on the indicator and embedding the assessment data as metadata in one or more selected candidate images.

Optionally, the one or more programs when executed by the one or more processors cause the processor to determine one or more status indicators about the one or more identified objects of interest and embedding the one or more status indicators as metadata that accompanies the one or more selected candidate images.

In one or more examples, a computer-readable storage medium can store one or more programs for identifying objects of interest from image data, the one or more programs comprising instructions which, when executed by an electronic device with a display and a user input interface, cause the device to: identify an indicator from the plurality of supporting evidence that indicates an object of interest may be located in a particular geolocation at a particular time, select one or more candidate images from a plurality of digital images based on the indicator, segment one or more potential objects of interest from the one or more selected candidate images, wherein segmenting the one or more potential objects of interest from the one or more selected candidate images comprises applying one or more segmentation analytics to the one or more selected candidate images to identify the one or more potential objects of interest, determine whether each of the one or more segmented potential objects of interest is an object of interest, determine an object type for each identified object of interest, and determine whether each identified object of interest is a specific known object of interest.

Optionally, determining whether each of the one or more segmented potential objects of interest is an object of interest comprises applying one or more object detection analytics comprising one or more object detection classifiers to the one or more selected candidate images.

Optionally, the one or more object detection analytics identify one or more environmental characteristics in the one or more selected candidate images, and determining whether each of the one or more segmented potential objects of interest is an object of interest comprises: selecting one or more scene classifiers from a plurality of scene classifiers based on the identified one or more environmental characteristics, and applying one or more scene analytics comprising the one or more selected scene classifiers to the one or more selected candidate images.

Optionally, determining the object type for each identified object of interest comprises: selecting one or more object type classifiers from a plurality of object type classifiers, and applying one or more object type analytics comprising the one or more selected object type classifiers to the one or more selected candidate images.

Optionally, the one or more object type classifiers are selected based on the results of applying the one or more object detection analytics.

Optionally, determining whether each identified object of interest is a specific known object of interest comprises: selecting one or more known object classifiers from a plurality of known object classifiers, and applying one or more known object analytics comprising the one or more selected known object classifiers to the one or more selected candidate images.

Optionally, the one or more known object classifiers are selected based on the results of applying the one or more object type analytics.

Optionally, the one or more programs comprising instructions which, when executed by an electronic device with a display and a user input interface, cause the device to generate assessment data based on the indicator and embedding the assessment data as metadata in one or more selected candidate images.

Optionally, the one or more programs comprising instructions which, when executed by an electronic device with a display and a user input interface, cause the device to determine one or more status indicators about the one or more identified objects of interest and embedding the one or more status indicators as metadata that accompanies the one or more selected candidate images.

It will be appreciated that any of the variations, aspects, features and options described in view of the systems can be combined.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE DRAWINGS

The invention will now be described, by way of example only, with reference to the accompanying drawings, in which:

FIG. 1 illustrates an exemplary process for disambiguating aircraft from images, in accordance with one or more examples of the disclosure;

FIG. 2 depicts an exemplary analytic process for selecting candidate images that may depict aircraft, in accordance with one or more examples of the disclosure;

FIG. 3 illustrates an exemplary analytic process for segmenting potential aircraft from candidate images, in accordance with one or more examples of the disclosure;

FIG. 4 illustrates an exemplary candidate image and a segmented candidate image, in accordance with one or more examples of the disclosure;

FIG. 5 illustrates an exemplary analytic process for disambiguating aircraft from candidate images, in accordance with one or more examples of the disclosure;

FIG. 6 illustrates an exemplary analytic process for determining whether a potential aircraft is an aircraft based in part on scene evaluation analytics, in accordance with s one or more examples of the disclosure;

FIG. 7 illustrates an exemplary supervised training process for generating a machine-learning model according to one or more examples of the disclosure; and

FIG. 8 illustrates an exemplary computing device, in accordance with one or more examples of the disclosure.

### DETAILED DESCRIPTION OF THE DISCLOSURE

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Described herein are systems and methods for identifying and disambiguating an object of interest from a data set. An object of interest can include, for example, aircraft (such as an airplane or helicopter), cars, trucks, boats, tanks, artillery, weapons, etc. In one or more examples, a plurality of supporting evidence can be received, the supporting evidence containing information regarding where particular objects of interest (such as aircraft) can be located. In one or more examples, an indicator can be identified from the plurality of supporting evidence that a particular object of interest may be located in a particular geolocation at a particular time. In one or more examples, images pertaining to the particular geolocation and particular time can be obtained. In one or more examples, the received images can be satellite images acquired from one or more satellites. In one or more examples, assessment data can be generated based on the indicator, which can illustrate why a particular image or images were obtained. In one or more examples, the images obtained can be stored as candidate image data in a candidate image database.

In one or more examples, prior to storing the images as candidate images, scene evaluation analytics can be performed on the obtained images. One or more relevant classifiers can be selected based on the scene evaluation analytics results. The one or more relevant classifiers can then be applied to the obtained satellite image data to identify one or more candidate images. In one or more examples, the one or more candidate images can then be stored in a candidate image database.

In one or more examples, once one or more candidate images have been stored in the candidate image database, the one or more candidate images can be processed to disambiguate one or more specific objects of interest from the one or more candidate images. In one or more examples, object-detection segmentation can be performed on received candidate images. The object-detection segmentation can detect one or more objects that resemble objects of interest. Upon detecting one or more objects in the candidate image data, first analytics can be performed on the one or more objects to identify objects that are objects of interest. In one or more examples, one or more relevant object type classifiers can be selected based on the first analytics results. The one or more object type classifiers can then be applied to the one or more objects when performing second analytics to identify objects of interest that are a specific type of object. In one or more examples, one or more relevant specific object type classifiers can be selected based on the second analytics results. The one or more specific object type classifiers can then be applied to one or more objects that are the specific type of object when performing third analytics to identify a specific object of interest. In one or more examples, identifying a specific object can involve classifying that object as a new disambiguated object or a known disambiguated object. In one or more examples, upon classifying a disambiguated object as either a known or a new disambiguated object, the object can be stored in one or more databases according to the classification.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

To detect and monitor objects of interest, defense and intelligence analysts can rely on tip-and-cue workflows which involve monitoring an area or an object of interest with a sensor and requesting (tipping) another sensor to acquire an image over the area (cueing). Tip and cue workflows can be performed by satellites. For instance, a satellite may monitor a particular area by periodically scanning image data collected from that area to identify changes in the location and/or status of objects in the image data. If a change is detected, the satellite may focus on the area and obtain more image data, which can be used by an analyst to assess the defense or intelligence importance of the detected changes.

In one or more examples, the tip-and-cue workflow can require some form of intelligence data that indicates where to look for objects of interest. Generally, this may result in tip-and-cue systems monitoring the same geographic areas or predictable areas such as airports or military installations. Limiting the search area to only known locations, however, means that monitoring objects of interest as they travel or if they move to new locations is impractical. Other forms of intelligence data can provide valuable information regarding where to look for objects of interest. For example, commercial data can be purchased from a supplier that provides imagery data from satellites. Alternatively, public data can be collected and assessed to identify locations where objects of interest are likely to be found. However, combing through public data to identify such locations can be a tedious and time-intensive task requiring collection of data from a myriad of sources and review of that data to spot relevant indicators.

Machine learning can be used to reduce the amount of human effort and time necessary to complete a variety of tasks. In one or more examples of the disclosure, and as described in detail below, machine learning can be applied to amass and review any sort of data, be it commercial or public, to obtain images that may depict objects of interest. After obtaining such images, in one or more examples, machine learning can also be used to process those images to determine which, if any, objects in those images do in fact depict objects of interest. Further, machine learning can be used to determine which of those objects of interest are a specific type of object, and even to disambiguate specific objects of interest. That is, machine learning can be used to identify which unique object of interest is depicted in an image.

Disambiguating specific objects of interest via a machine-learning method, however, requires a large volume of information. Namely, such process requires machine-learning classifiers related to the specific objects of interest and related to the type of object. Moreover, such classifiers must broadly span various environmental conditions such as different types of weather or differing contrast levels of objects of interest relative to background that may complicate detecting an object of interest and determining defining features of that object of interest in order to classify and disambiguate that object of interest. Moreover, before even attempting to disambiguate a specific object of interest, images that may depict objects of interest must be selected, and potential objects of interest must be identified in those images.

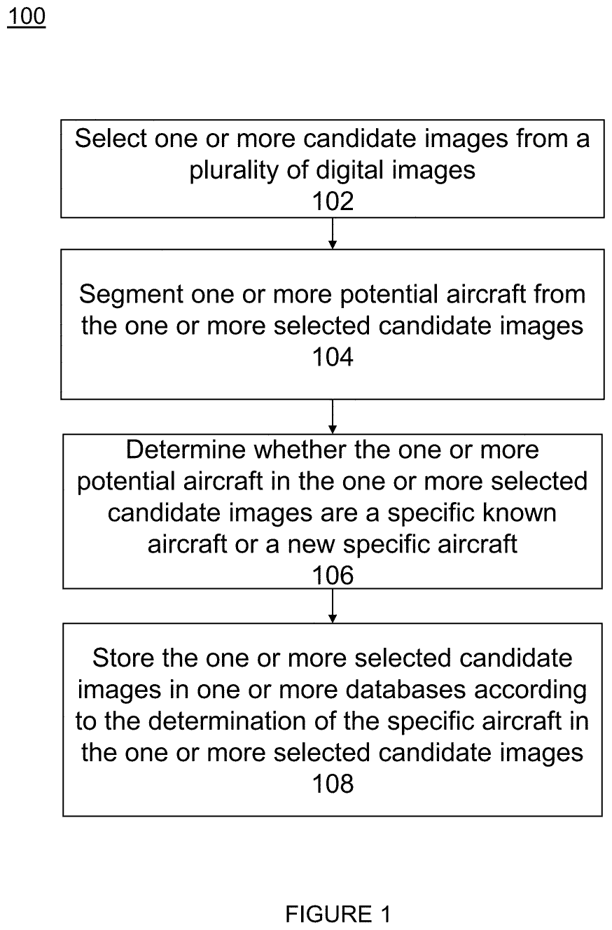

FIG. 1 illustrates an exemplary process 100 for disambiguating aircraft from image data, in accordance with one or more examples of the disclosure. In one or more examples, the process 100 of FIG. 1 can represent a process for disambiguating aircraft and storing the information relating to the disambiguated aircraft by obtaining a plurality of supporting evidence (described in detail below) and/or satellite images and relying on a variety of machine-learning classifiers to disambiguate the aircraft from obtained images. In one or more examples, the machine-learning classifiers used to disambiguate the aircraft can be selected based on analytics that indicate which classifiers are relevant (e.g., classifiers related to certain weather conditions or a particular class of aircraft, etc.) based on the specific image. It should be noted that the process 100 is not limited to disambiguating aircraft from image data and can be used to disambiguate other objects of interest, such as cars, trucks, boats, tanks, artillery, weapons, etc.

In one or more examples, the process 100 can begin at step 102, wherein one or more candidate images are selected from a plurality of digital images. The candidate images can represent images that may depict aircraft, and thus that are candidates for disambiguation. The plurality of digital images can include images photographed from the ground at different angles. In one or more examples, in addition to or alternatively, the plurality of digital images can include satellite images received from one or more commercial sources. For example, the satellite images can be received from one or more commercial entities that provide satellite images from a constellation of satellites that obtain images of various locations. The satellite images can include visible RGB images and/or infrared images.

In one or more examples, the plurality of digital images can include, in addition to or alternatively to the images described above, satellite images received from one or more public sources. For example, the satellite images can be received from one or more public repositories of freely available satellite images. The satellite images can include visible RGB imagery and/or infra-red imagery. In one or more examples, satellite images can be received from one or more automatic dependent surveillance broadcast (ADS-B) platforms that broadcast a live feed of surveillance imagery. Live feed surveillance imagery data can be received for ADS-B-equipped aircraft. Such live feed imagery data can include a timestamp, altitude, latitude/longitude, groundspeed, heading, specific aircraft identification, etc. In one or more examples, the plurality of digital images can include a set of satellite images that are already categorized as either containing aircraft (“plane”) or not containing aircraft (“no plane”) from a publicly available source.

As noted above, the candidate images can represent images that may depict aircraft, and thus that are candidates for disambiguation. However, to select the one or more candidate images from a plurality of digital images at step 102, it may be necessary to review hundreds or even thousands of images, and to determine, for each individual image, whether a given image may depict an aircraft. It would be impractical to perform such selection in the human mind due to the sheer volume of data that must be processed in order to select candidate images that may depict aircraft.

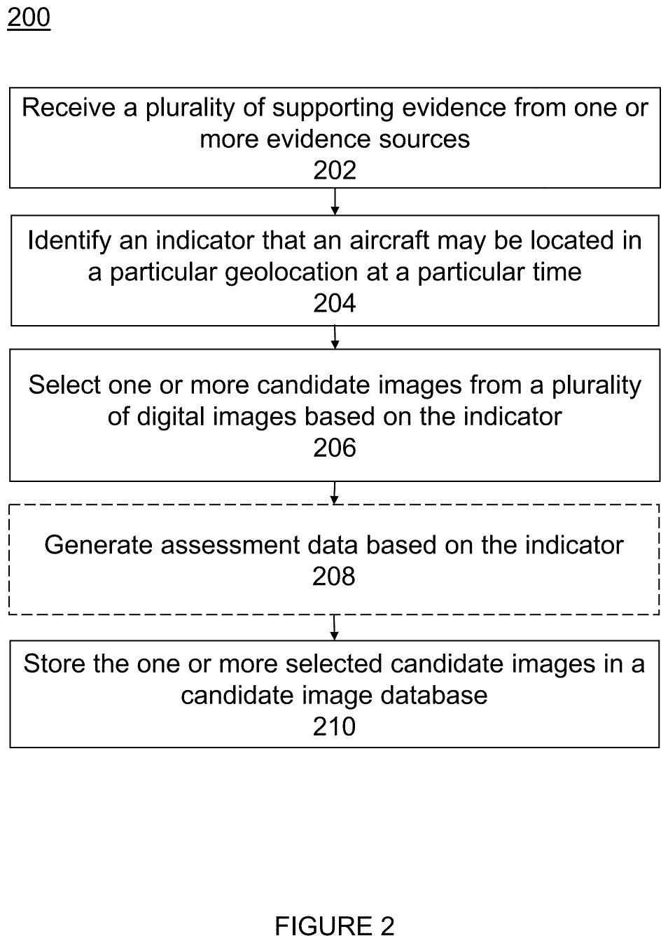

Accordingly, FIG. 2 depicts an exemplary analytic process 200 for selecting candidate images that may depict aircraft, in accordance with one or more examples of the disclosure. In one or more examples, the analytic process 200 of FIG. 2 can represent an exemplary analytic process for selecting candidate images based on an indicator that an aircraft may be located in a particular geolocation at a particular time. In one or more examples, the analytic process 200 can be performed by an automated candidate image identification pipeline that can include one or more computer-based analytics that can include one or more machine-learning classifiers. The one or more machine learning classifiers can be generated via a supervised training process, as will be described further below. An automated candidate image identification pipeline can include a process in which images are processed to determine whether an image contains an aircraft, with minimal or no human intervention, thus reducing the time and labor needed to identify images that are candidates for disambiguation. It should be noted that the process 200 is not limited to selecting candidate images that depict aircraft and may be used to select candidate images that depict other objects of interest, such as cars, trucks, boats, tanks, artillery, weapons, etc.

As shown in FIG. 2, the analytic process 200 can begin with step 202 wherein a plurality of supporting evidence is received from one or more evidence sources. The supporting evidence can include one or more photographs and/or satellite images from a public or commercial source, as discussed above. In one or more examples, the supporting evidence can include, in addition to or alternatively, supplemental data from one or more alternative data sources. Alternative data sources can include social media sources, official reports, news reports, shipping information, etc. For instance, supporting evidence can include reports of plane crashes or incidents, GPS-enabled social media posts, posts from one or more specific social media profiles known to report plane movements such as the social media account of a pilot, following tracking numbers pertaining to shipments of aircraft and or subcomponents of aircraft or shipments from aircraft manufacturers, etc. Supporting evidence can also include information indicating common locations where specific aircraft are likely to be found, such as near an airport, military base, or aircraft boneyard.

In one or more examples, once the plurality of supporting evidence is received at step 202, the process 200 of FIG. 2 can move to step 204 wherein an indicator that a relevant object (e.g., an aircraft) may be located in a particular geolocation at a particular time is identified. For instance, where the supporting evidence includes information of a report of a plane crash at a specific location, the report may be identified as an indicator that a plane may be at that specific location at a particular time. In one or more examples, identifying the indicator may occur substantially in real-time upon receiving supporting evidence. Alternatively, identifying the indicator may occur at regular periodic intervals such as once each day at the same time or every six hours.

Upon identifying an indicator at step 204, the process 200 can move to step 206 and select one or more candidate images from a plurality of digital images based on the indicator identified at step 204. In one or more examples, selecting the one or more candidate images at step 206 may involve searching one or more public or private databases of satellite, aerial, or ground images to select images based on the indicator. For example, if the indicator suggests that images from a particular geolocation at a particular time are likely to depict an aircraft, selecting the one or more candidate images can involve selecting images from a database at that particular geolocation and particular time. Where the indicator is identified substantially in real-time upon receiving supporting evidence, selecting the one or more candidate images at step 206 can, in one or more examples, involve directing a satellite to obtain new satellite imagery of the particular geolocation. Selecting the one or more candidate images can also involve directing a drone or other surveillance aircraft to obtain aerial imagery, or directing a ground-based sensor to obtain one or more photographs of the particular geolocation, etc.

After selecting the one or more candidate images at step 206, the analytic process 200 can move to step 208 wherein assessment data based on the indicator is generated. In one or more examples, the assessment data can provide useful information relating to what source and/or type of information received at step 202 provided information that a relevant object was likely to be located at a particular geolocation at a particular time. That is, the assessment data can provide a record of why the method 200 was “tipped” and “cued” to obtain one or more images. In one or more examples, the assessment data can be stored as metadata associated with the one or more selected candidate images. In one or more examples, step 208 can be optional.

After generating assessment data at step 208 (or after selecting candidate images at step 206 if step 208 is not performed), in one or more examples, the analytic process 200 can move to step 210 and store the one or more selected candidate images in a candidate image database. The candidate image database can, in one or more examples, be hosted on a central server or may be hosted on one or more remote servers.

Referring back now to FIG. 1, after selecting one or more candidate images from a plurality of digital images at step 102, the process 100 can move to step 104, wherein one or more potential aircraft are segmented from the one or more selected candidate images. Segmenting the one or more potential aircraft from the one or more selected candidate images can involve reviewing each candidate image to determine whether there are objects that resemble aircraft and providing some type of identifier that emphasizes those objects. An identifier can include a visual identifier such as an object-detection box (or other shape) on each identified object, an annotation on an image that identifies characteristics contained within the image, adding other visual identifiers to the images, removing pixels that were not identified as pixels corresponding to a potential aircraft, altering the color of pixels of the images according to the identification of the one or more potential aircraft, etc. Segmenting each potential aircraft from every selected candidate image, however, may be an onerous and time-consuming endeavor. As above, it would be impractical to perform such segmentation in the human mind due to the sheer volume of data that must be reviewed individually in order to identify objects that may be aircraft and then to include some form of identifier for each potential aircraft.

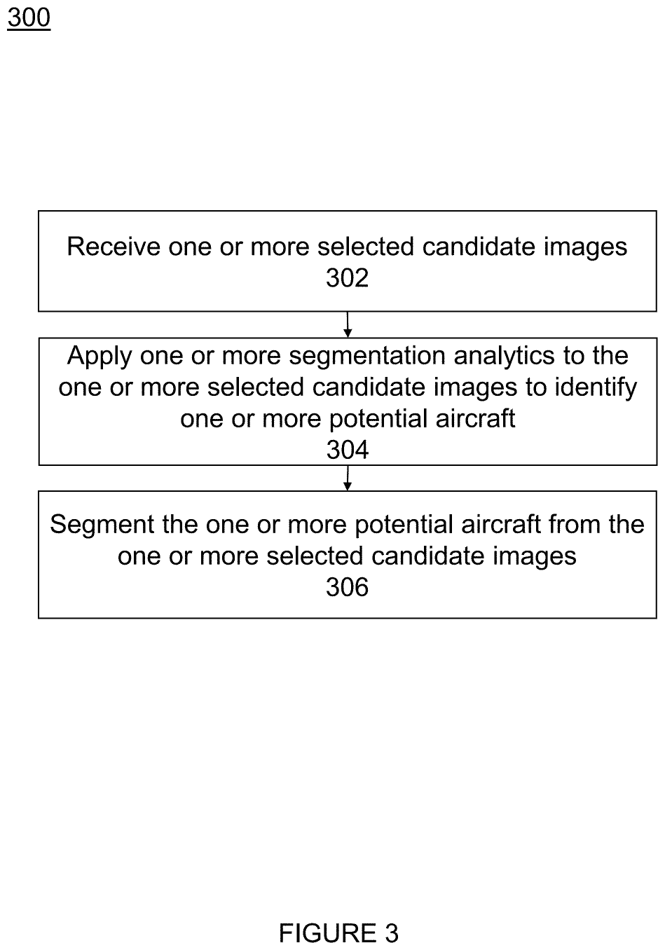

Accordingly, FIG. 3 depicts an exemplary analytic process 300 for segmenting potential aircraft from candidate images, in accordance with one or more examples of the disclosure. In one or more examples, the analytic process 300 of FIG. 3 can represent an exemplary analytic process for identifying objects that may be aircraft, and including a visual identifier such as an object-detection box on each identified object. In one or more examples, the analytic process 300 can be performed by an automated aircraft segmentation pipeline. The automated aircraft segmentation pipeline can include one or more computer-based analytics that can include one or machine-learning classifiers. The one or more machine-learning classifiers can be generated via a supervised training process, as will be described further below. The analytic process 300 can also be performed by another suitable computer-based object detection process. It should be noted that the process 300 is not limited to segmenting potential aircraft from candidate images and can be used to segment other objects of interest, such as cars, trucks, boats, tanks, artillery, weapons, etc.

As shown in FIG. 3, the analytic process 300 can begin with step 302 wherein one or more selected candidate images are received. The one or more selected candidate images can be selected via the analytic process 200, and may be received from the candidate image database wherein the one or more selected candidate images were stored at step 210 of analytic process 200.

After receiving one or more selected candidate images at step 302, the analytic process 300 can move to step 304 wherein one or more segmentation analytics are applied to the one or more selected candidate images to identify one or more potential aircraft. The one or more segmentation analytics can be part of an automated aircraft segmentation pipeline that can include one or more machine-learning classifiers, as discussed above.

After identifying the one or more potential aircraft at step 304, the analytic process 300 can move to step 306 wherein the one or more potential aircraft are segmented from the one or more selected candidate images. As explained above, segmenting the one or more potential aircraft from the one or more selected candidate images can include adding a visual identifier such as an object-detection box on each identified object. Segmenting the one or more potential aircraft from the one or more selected candidate images can also include other visual indicators such as, for example, adding other visual identifiers to the one or more candidate images, removing pixels that were not identified as pixels corresponding to a potential aircraft, altering the color of pixels of the one or more candidate images according to the identification of the one or more potential aircraft, etc.

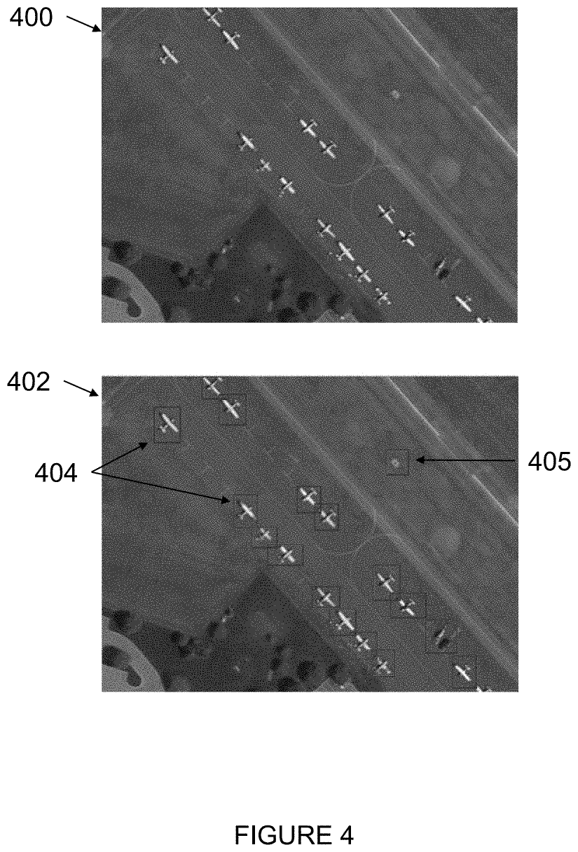

FIG. 4 illustrates an exemplary candidate image 400, according to one or more examples of the disclosure. As shown in FIG. 4, the candidate image 400 is satellite image that includes multiple aircraft. As explained above, the candidate image may also, in one or more examples, be obtained from a drone-based camera. Accordingly, though in FIG. 4 the candidate image 400 is represented as an aerial view, the process 400 is not limited to only aerial view photos. As discussed above, the candidate image may also be photographic imagery obtained from a ground-based camera. Accordingly, the candidate image may depict objects such as aircraft from a variety of reference points.

FIG. 4 also depicts an exemplary segmented candidate image 402, according to one or more examples of the disclosure. As shown in FIG. 4, the segmented candidate image 402 includes the same candidate image 400 with object-detection boxes 404, 405 superimposed on top of the candidate image 400 on a variety of detected objects. As a computerized process may be less accurate when initially identifying potential aircraft, in one or more examples, the segmented candidate image may include object-detection boxes on objects that are false positives because they are not aircraft. For example, as shown in FIG. 4, the object-detection boxes 404 do in fact identify aircraft as potential aircraft. However, object-detection box 405 identifies a non-aircraft object, and is a false positive.

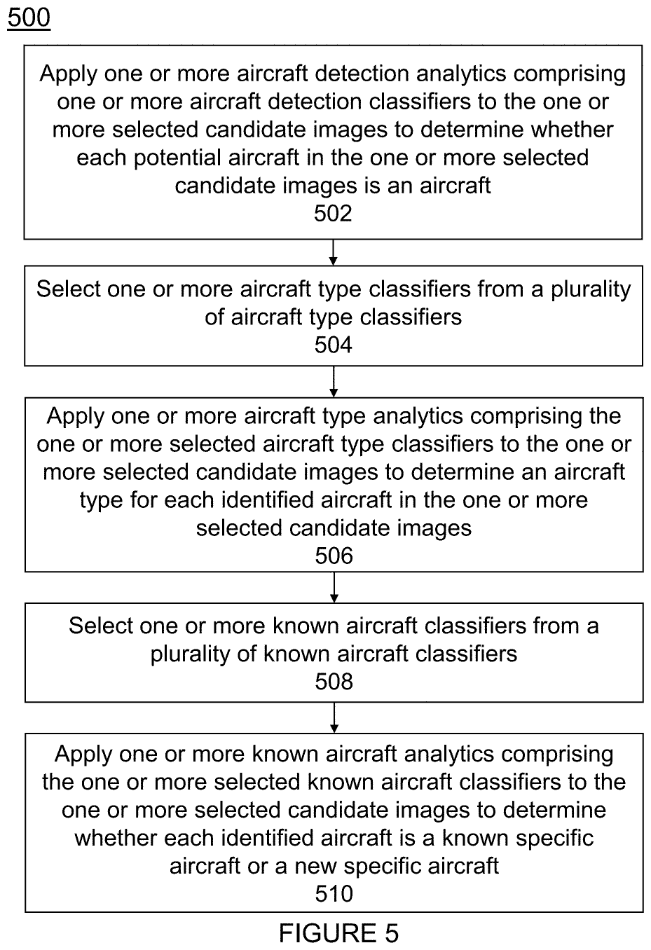

Referring now back to FIG. 1, after segmenting the one or more potential aircraft from the one or more selected candidate images, the process 100 can move to step 106, and determine whether the one or more potential aircraft in the one or more selected candidate images is a known specific aircraft or a new specific aircraft. In one or more examples, any false positives identified as objects of interest at step 104 of process 100 can be screened out during step 106. Determining whether the one or more potential aircraft are a specific known aircraft, or disambiguating the potential aircraft, can involve determining whether each of the segmented potential aircraft in the one or more selected candidate images is in fact an aircraft, determining an object type for each determined aircraft, and then determining whether the aircraft is a specific known aircraft. As above, it would be impractical to perform such disambiguation in the human mind due to the sheer volume of data that must be reviewed individually in order to identify aircraft, identify an object type, and then identify whether the specific identified aircraft is a known specific aircraft. Accordingly, FIG. 5 depicts an exemplary analytic process 500 for disambiguating aircraft from candidate images, in accordance with one or more examples.

In one or more examples, the analytic process 500 of FIG. 5 can represent an exemplary analytic process for disambiguating specific aircraft from one or more candidate images. In one or more examples, the analytic process 500 can be performed by an automated aircraft disambiguation pipeline. The automated aircraft disambiguation pipeline can include one or more computer-based analytics that can include one or more machine-learning classifiers. The one or more machine-learning classifiers can be generated via a supervised training process, as will be described further below. The automated aircraft disambiguation pipeline can disambiguate specific aircraft from one or more candidate images with minimal or no human intervention, thus reducing the time and labor needed to disambiguate specific aircraft in candidate images. It should be noted that the process 500 is not limited to disambiguating aircraft from candidate images and can be used to disambiguate other objects of interest, such as cars, trucks, boats, tanks, artillery, weapons, etc.

As shown in FIG. 5, the analytic process 500 can begin with step 502 with applying one or more object detection analytics comprising one or more object detection classifiers to the one or more selected candidate images to determine whether each potential aircraft in the one or more selected candidate images is an aircraft. In one or more examples, the one or more object detection classifiers can be selected from a plurality of object detection classifiers. The one or more object detection classifiers may be selected based on the results of segmenting the one or more potential aircraft from the one or more selected candidate images at step 104. For example, if a particular segmented potential aircraft occupies a large portion of a selected candidate image, object detection classifiers corresponding to large aircraft may be selected.

In one or more examples, the object detection analytics may comprise one or more analytics for disambiguating aircraft from candidate images that depict specific environmental conditions. For instance, a given candidate image may clearly depict an aircraft sitting squarely on a tarmac in bright sunny weather conditions. A candidate image may alternatively depict an aircraft amidst a variety of weather conditions such as snow or rain that obscures the aircraft, or that depicts the aircraft with a range of backgrounds such as desert or grass. The candidate image may also depict only part of an aircraft. For example, a candidate image may depict the tail of an aircraft protruding out of the back of an aircraft hangar. The above environmental conditions are provided for example only and are not intended to, and should not construed to, be limiting in any way.

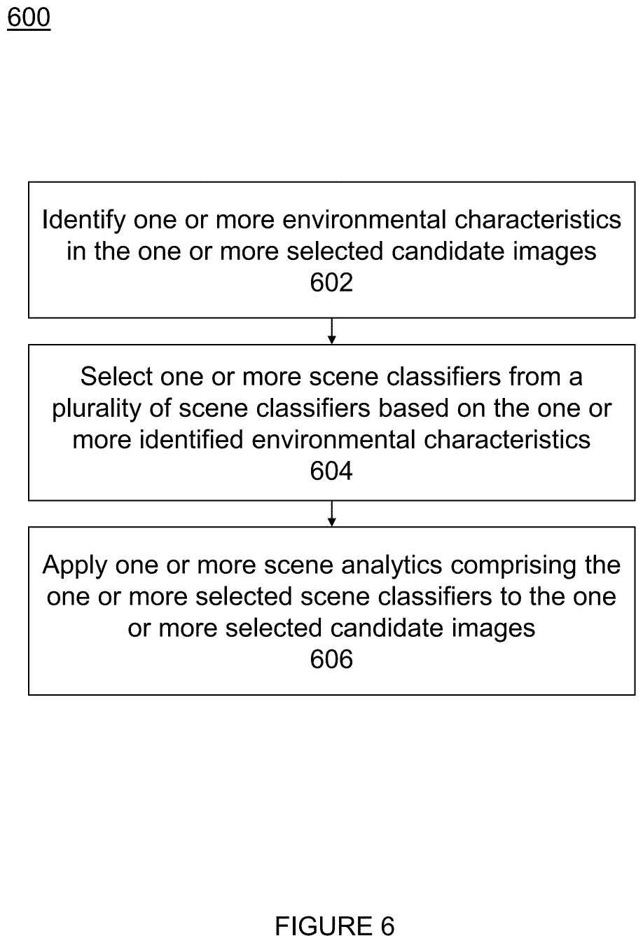

Accordingly, in order to determine whether a potential aircraft is in fact an aircraft, the object detection analytics may comprise scene evaluation analytics. FIG. 6 illustrates an exemplary analytic process 600 for determining whether a potential aircraft is an aircraft based in part on scene evaluation analytics, in accordance with one or more examples of the disclosure. In one or more examples, the process 600 of FIG. 6 can represent an exemplary process identifying environmental characteristics (e.g., conditions) in the one or more selected candidate images, selecting scene classifiers based on those environmental characteristics, and applying scene analytics comprising the one or more selected scene classifiers to determine whether a potential aircraft is an aircraft. In one or more examples, the analytic process 600 may be performed as part of applying the one or more object detection analytics at step 502 of analytic process 500. It should be noted that the process 600 is not limited to determining whether a potential aircraft is an aircraft and can be used in the same manner to determine whether other potential objects of interest are in fact such objects, such as cars, trucks, boats, tanks, artillery, weapons, etc.

As shown in FIG. 6, analytic process 600 can begin with step 602 by identifying one or more environmental characteristics in the one or more selected candidate images. In one or more examples, identifying one or more environmental characteristics can involve reviewing each of the one or more selected candidate images to identify which, if any, of a plurality of environmental characteristics are present in each of the one or more selected candidate images. For example, if a particular selected candidate image depicts one or more objects amidst a green background, step 602 of analytic process 600 can involve identifying the green background as an environmental characteristic for that particular selected candidate image.

In one or more examples, the plurality of scene classifiers may each correspond to one of a plurality of environmental characteristics. The plurality of environmental characteristics can, in one or more examples, represent the universe of environmental characteristics that can be analyzed using the analytic process 600. Accordingly, identifying the one or more environmental characteristics in the one or more selected candidate images at step 602 of analytic process 600, can involve narrowing the universe of environmental characteristics to a smaller subset of environmental characteristics that are relevant based on the environmental characteristics that were identified for the specific selected candidate image.

After identifying the one or more environmental characteristics at step 602, the analytic process 600 can move to step 604 and select one or more scene classifiers from a plurality of scene classifiers based on the one or more identified environmental characteristics. In one or more examples, the scene classifiers may be stored in a scene classifier database. Selecting the one or more scene classifiers at step 604 of analytic process 600 can involve selecting only the scene classifiers that are implicated for a given selected candidate image. That is, where a given selected candidate image is identified to have a green background at step 602, scene classifiers that correspond to green backgrounds may be implicated and selected, whereas scene classifiers that correspond to black backgrounds, for example at night, may not be selected. Alternatively, if at step 602, the analytic process 600 identifies a white background, scene classifiers that have a white background, such as those that depict aircraft in snowy conditions, may be selected at step 604 of analytic process 600. By selecting the scene classifiers that are implicated based on the one or more identified environmental characteristics, the overall computing effort of the analytic process 600 may be reduced.

After selecting one or more scene classifiers at step 604, the analytic process can move to step 606 and apply one or more scene analytics comprising the one or more selected scene classifiers to the one or more selected candidate images. In one or more examples, the scene analytics can be performed by a machine-learning pipeline that has been trained using a variety of reference images depicting different environmental characteristics. The result of applying the one or more scene analytics at step 606 can be a confidence score that indicates with what degree of confidence the analytic process 600 has determined a particular potential aircraft depicted in a particular selected candidate image to be an aircraft.

In one or more examples, the more applicable the scene classifiers applied in the scene analytics at step 606, the more accurate the confidence score will be. Thus, by selecting scene classifiers at step 604 based on the environmental characteristics identified at step 602 before applying one or more scene analytics comprising the one or more selected scene classifiers at step 606, the analytic process 600 can result in a more accurate determination of whether a potential aircraft is an aircraft. For example, if an aircraft in a specific selected candidate image is depicted in snowy conditions with a white background, scene classifiers corresponding to aircraft depicted at night with darkly colored backgrounds may result with a less accurate determination as to whether the potential aircraft is an aircraft. Accordingly, by selecting one or more scene classifiers at step 604 based on the environmental characteristics identified in a given selected candidate image at step 602, the scene analytics applied at step 606 are tailored to the environmental conditions present in that particular selected candidate image and thus can more accurately determine whether a potential aircraft is in fact an aircraft.

Where multiple scene classifiers were selected at step 604, the scene analytics applied at step 606 can involve applying those scene classifiers concurrently or in succession. In one or more examples, by applying the one or more selected scene classifiers to the one or more obtained images, the analytic process 600 can determine whether or not the one or more segmented potential aircraft in the one or more selected candidate images are in fact aircraft.

Referring now back to FIG. 5, after applying one or more object detection analytics at step 502, the analytic process 500 can move to step 504 and select one or more object type classifiers from a plurality of object type classifiers. The plurality of object type classifiers can represent the universe of possible object types that a given segmented aircraft may be. For example, the object type classifiers can include classifiers corresponding to each type of plane that exists. In one or more examples, selecting the one or more object type classifiers at step 504 can be based on the results of the object detection analytics applied at step 502. For instance, if at step 504 the object detection analytics determined that a potential segmented aircraft was in fact a fixed-wing aircraft, only object type classifiers corresponding to fixed-wing aircraft will be selected, and object type classifiers corresponding to, for example, helicopters, will not be selected. As discussed above, selecting classifiers that are tailored to the aircraft depicted in a given selected candidate image can improve the accuracy of the analytic process 500 and reduce the computing effort required to perform the analytic process.

After selecting the one or more object type classifiers at step 504, the analytic process 500 can move to step 506 and apply one or more object type analytics comprising the one or more selected object type classifiers to the one or more selected candidate images to determine an object type for each identified aircraft in the one or more selected candidate images. In one or more examples, the object type analytics can be performed by a machine-learning pipeline that has been trained using a variety of reference images depicting different object types. The result of applying the one or more object type analytics at step 506 can be a confidence score that indicates with what degree of confidence the analytic process 500 has determined a particular identified aircraft is a particular object type. For example, the object type analytics may return a confidence score determining whether a particular identified aircraft is a B-52.

In one or more examples, the analytic process 600 may determine what portion of each of the identified aircraft depicted in a given selected candidate image is visible. For instance, where a given candidate image depicts only the tail portion of an aircraft, the analytic process 600 may determine that only 10% of the identified aircraft is depicted in the selected candidate image. Determining what portion of each aircraft-image is depicted in a given candidate image may, in one or more examples, be performed as part of applying the one or more object type analytics at step 506 of analytic process 500.

In one or more examples, as part of step 506, the process 500 may include determining whether each identified aircraft is a candidate for disambiguation based on the portion of the aircraft-object that is visible in the candidate image. For example, if 80% of a given identified aircraft is visible, that aircraft object may be identified as a candidate for disambiguation. Alternatively, if less than 20% of a given identified aircraft is visible, that identified aircraft may not be identified as a candidate for disambiguation. These percentages are used as example only and are not intended, nor should they be construed, as being limiting.

After determining an object type for each identified aircraft in the one or more selected candidate images at step 506, the analytic process 500 can move to step 508 and select one or more known object classifiers from a plurality of known object classifiers. The plurality of known object classifiers can represent the universe of possible known specific aircraft. That is, there may exist one known object classifier for each known aircraft.

In one or more examples, selecting the one or more known object classifiers at step 508 can be based on the results of the object type analytics applied at step 506. For instance, if at step 506 the object type analytics determined that an identified aircraft is a B-52, only known object type classifiers corresponding to B-52s may be selected at step 508. As discussed above, selecting classifiers that are tailored to the aircraft depicted in a given selected candidate image can improve the accuracy of the analytic process 500 and reduce the computing effort required to perform the analytic process.

In one or more examples, the known object classifiers may be selected based on distinguishing features of a particular type of aircraft. For example, if a particular identified aircraft is identified as a B-52 that is red and has an alphanumeric code on the aircraft tail, only known object classifiers of B-52s that also are red and have an alphanumeric code on the aircraft tail will be selected at step 508. The known object classifiers may be selected based on one or more distinguishing features. That is, if the particular identified aircraft being analyzed is a red aircraft with an alphanumeric code on the aircraft's tail, known object classifiers can be selected based on one or both of those distinguishing features. Other examples of distinguishing features can include, in non-limiting examples, color, defects such as scuffs or dents, modifications to the aircraft, etc.

After selecting the one or more known object classifiers at step 508, the analytic process 500 can move to step 510 and apply one or more known object analytics comprising the one or more selected known object classifiers to the one or more selected candidate images to determine whether each identified aircraft is a known specific aircraft or a new specific aircraft. In one or more examples, the known object analytics will only be performed on the identified aircraft that were identified as a candidate for disambiguation at step 506.

In one or more examples, the known object analytics can be performed by a machine-learning pipeline that has been trained using a variety of reference images depicting different known aircraft. The result of applying the one or more known object analytics at step 510 can be a confidence score that indicates with what degree of confidence the analytic process 500 has determined a particular identified aircraft is a specific known aircraft. For example, the known object analytics may return a confidence score determining whether a particular identified aircraft is a specific B-52.

In one or more examples, after determining whether each identified aircraft is a known specific aircraft or a new specific aircraft, the analytic process 500 can determine one or more relevant status indicators for one or more of the specific aircraft in the one more selected candidate images. Such relevant status indicators can include, for example, information that a given specific aircraft is in a take-off position about to leave, or that the specific aircraft is parked and has been parked in the same location for a period. Determining such relevant status indicators can include comparing the specific aircraft to one or more images in a database of disambiguated specific aircraft. In one or more examples, any relevant status indicators about the one or more specific aircraft that have been determined can be saved as metadata accompanying the corresponding candidate image.

Referring now back to FIG. 1, after determining whether the one or more potential aircraft in one or more selected candidate images are a specific known aircraft at step 106, the process 100 can move to step 108 and store the one or more selected candidate images in one or more databases according to the determination of the specific aircraft in the one or more selected candidate images. In one or more examples, a specific aircraft that is classified as either “new” or “known” can be stored in a disambiguated aircraft database. For instance, if a specific aircraft is classified as a new specific aircraft, the specific aircraft may be stored in the disambiguated aircraft database with some accompanying information that indicates this particular specific aircraft is a “new” disambiguated aircraft. For example, a specific aircraft may be classified as “new” if that specific aircraft does not contain the same identifying features as any other aircraft in the disambiguated aircraft database. If the specific aircraft is classified as a known specific aircraft, however, the specific aircraft may be stored in the disambiguated aircraft database with some accompanying information that indicates which other images, if any, in the disambiguated aircraft database depict the same known aircraft with the same identifying features. Such accompanying information can, in one or more examples, be saved as metadata for each particular candidate image as the candidate image is being stored in the one or more databases at step 108.

In one or more examples, the process 100 can be implemented by an automated aircraft disambiguation pipeline. In one or more examples, each of the analytic process 200, the analytic process 300, and the analytic process 500 can be performed by the automated aircraft disambiguation pipeline. The automated aircraft disambiguation pipeline can include one or more computer-based analytics that can include one or more machine-learning classifiers. The one or more machine-learning classifiers can be generated via a supervised training process.

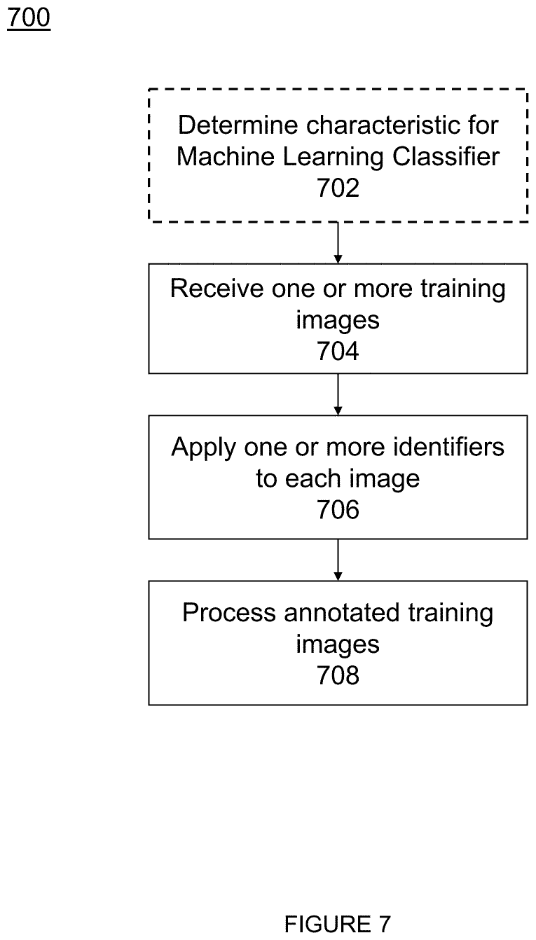

FIG. 7 illustrates an exemplary supervised training process 700 for generating a machine-learning model according to examples of the disclosure. In the example of FIG. 7, the process 700 can begin at step 702 wherein a particular characteristic for a given binary machine learning classifier is selected or determined (such as the presence of an aircraft, object type, orientation of an aircraft, etc.). In one or more examples, step 702 can be optional, as the selection of characteristics needed to for the machine learning classifiers can be selected beforehand in a separate process.

Once the one or more characteristics to be classified have been determined at step 702, the process 700 can move to step 704 wherein one or more training images corresponding to the selected characteristics are received. In one or more examples, each training image can include one or more identifiers/annotations that identify the characteristics contained within an image. The identifiers can take the form of annotations that are appended to the metadata of the image, identifying what characteristics are contained within the image.

In one or more examples, if the training images received at step 704 do not include identifiers, then the process can move to step 706 wherein one or more identifiers are applied to each image of the one or more training images. In one or more examples, the training images can be annotated with identifiers using a variety of methods. For instance, in one or more examples, the training images can be manually applied by a human or humans who view each training image, determine what characteristics are contained within the image, and then annotate the image with the identifiers pertaining to those characteristics. Alternatively or additionally, the training images can be harvested from images that have been previously classified by a machine classifier. In this way, each of the machine learning classifiers can be constantly improved with new training data (i.e., by taking information from previously classified images) so as to improve the overall accuracy of the machine learning classifier.

In one or more examples, and in the case of segmentation or region based classifiers such as R-CNNs (Regional Convolutional Neural Networks), the training images can be annotated on a pixel-by-pixel or regional basis to identify the specific pixels or regions of an image that contain specific characteristics. For instance in the case of R-CNNs, the annotations can take the form of bounding boxes or segmentations of the training images. Once at least one training image has one or more identifiers annotated to the image at step 706, the process 700 can move to step 708, wherein the at least one training image is processed by each of the machine learning classifiers in order to train the classifier. In one or more examples, and in the case of CNNs (Convolutional Neural Networks), processing the at least one training image can include building the individual layers of the CNN.

The systems and methods described above can be used to identify and disambiguate objects of interest from a data set such as one or more obtained images. The images can be obtained from a variety of sources based on an indicator that an object of interest is depicted in the image. The images classified as candidate images can be processed to determine whether a particular scene is depicted in order to more accurately detect the presence of one or more objects of interest in the images. The candidate images can be processed to determine whether a given candidate image depicts an object of interest, whether the object of interest is a specific type of object, and whether that object of interest of a specific type is a known disambiguated object of interest or a new disambiguated object of interest. The processing of the candidate images to identify known or new disambiguated objects of interest can provide vital intelligence for defense analysts with respect to where in the world objects of interest are located, how many such objects of interest are located in each location, useful information regarding the status of those objects of interest, etc. The description of the systems and methods described above have been made using the example of detecting aircraft in satellite or aerial images, but the example should not be seen as limited to this context. In one or more examples, the above disclosure can be applied to other object or characteristic identification in images using machine-learning classifiers, as would be appreciated by a person of skill in the art. Exemplary machine-learning classifiers may include support vector machine (SVM) classifiers, random forest classifiers, Haar Cascade classifiers, etc.

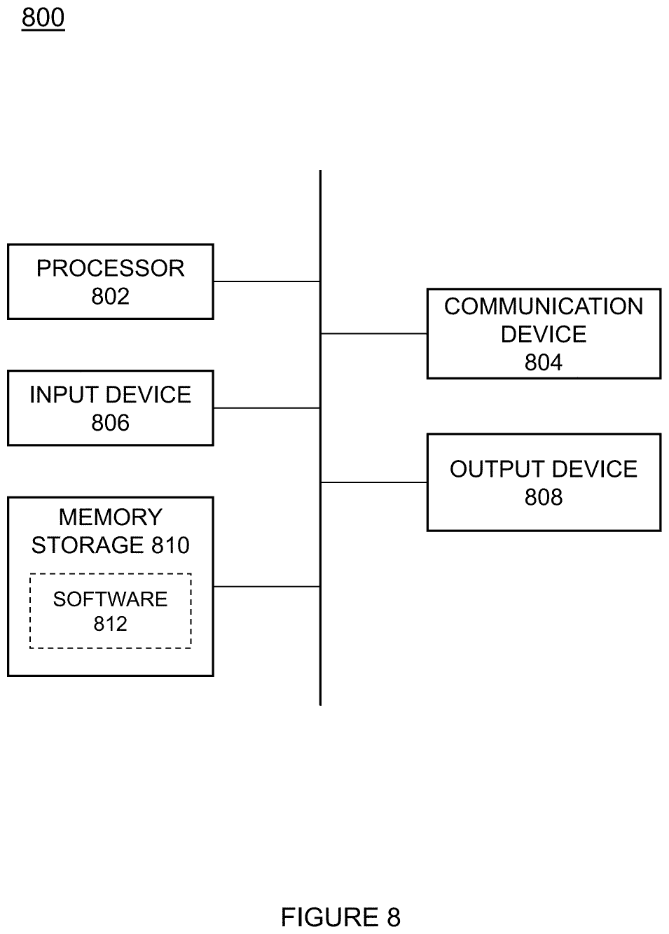

FIG. 8 illustrates an example of a computing device 800 in accordance with one examples of the disclosure. Device 800 can be a host computer connected to a network. Device 800 can be a client computer or a server. As shown in FIG. 8, device 800 can be any suitable type of microprocessor-based device, such as a personal computer, workstation, server, or handheld computing device (portable electronic device) such as a phone or tablet. The device can include, for example, one or more of processors 802, input device 806, output device 808, storage 810, and communication device 804. Input device 806 and output device 808 can generally correspond to those described above and can either be connectable or integrated with the computer.

Input device 806 can be any suitable device that provides input, such as a touch screen, keyboard or keypad, mouse, or voice-recognition device. Output device 808 can be any suitable device that provides output, such as a touch screen, haptics device, or speaker.

Storage 810 can be any suitable device that provides storage, such as an electrical, magnetic, or optical memory, including a RAM, cache, hard drive, or removable storage disk. Communication device 804 can include any suitable device capable of transmitting and receiving signals over a network, such as a network interface chip or device. The components of the computer can be connected in any suitable manner, such as via a physical bus or wirelessly.

Software 812, which can be stored in storage 810 and executed by processor 802, can include, for example, the programming that embodies the functionality of the present disclosure (e.g., as embodied in the devices as described above).

Software 812 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 810, that can contain or store programming for use by or in connection with an instruction execution system, apparatus, or device.

Software 812 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 800 can implement any operating system suitable for operating on the network. Software 812 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for identifying objects of interest from image data, the method comprising:
receiving a plurality of supporting evidence from one or more evidence sources;
identifying an indicator from the plurality of supporting evidence that indicates an object of interest may be located in a particular geolocation at a particular time;
selecting one or more candidate images from a plurality of digital images based on the indicator;
segmenting one or more potential objects of interest from the one or more selected candidate images, wherein segmenting the one or more potential objects of interest from the one or more selected candidate images comprises applying one or more segmentation analytics to the one or more selected candidate images to identify the one or more potential objects of interest;
determining whether each of the one or more segmented potential objects of interest is an object of interest;
determining an object type for each identified object of interest; and
determining whether each identified object of interest is a specific known object of interest.

2. The method of claim 1, wherein determining whether each of the one or more segmented potential objects of interest is an object of interest comprises applying one or more object detection analytics comprising one or more object detection classifiers to the one or more selected candidate images.

3. The method of claim 2, wherein the one or more object detection analytics identify one or more environmental characteristics in the one or more selected candidate images, and determining whether each of the one or more segmented potential objects of interest is an object of interest comprises:
selecting one or more scene classifiers from a plurality of scene classifiers based on the identified one or more environmental characteristics; and
applying one or more scene analytics comprising the one or more selected scene classifiers to the one or more selected candidate images.

4. The method of claim 2, wherein determining the object type for each identified object of interest comprises:
selecting one or more object type classifiers from a plurality of object type classifiers; and
applying one or more object type analytics comprising the one or more selected object type classifiers to the one or more selected candidate images.

5. The method of claim 4, wherein the one or more object type classifiers are selected based on the results of applying the one or more object detection analytics.

6. The method of claim 4, wherein determining whether each identified object of interest is a specific known object of interest comprises:
selecting one or more known object classifiers from a plurality of known object classifiers; and
applying one or more known object analytics comprising the one or more selected known object classifiers to the one or more selected candidate images.

7. The method of claim 6, wherein the one or more known object classifiers are selected based on the results of applying the one or more object type analytics.

8. The method of claim 1, comprising generating assessment data based on the indicator and embedding the assessment data as metadata in one or more selected candidate images.

9. The method of claim 1, comprising determining one or more status indicators about the one or more identified objects of interest and embedding the one or more status indicators as metadata that accompanies the one or more selected candidate images.

10. A system for identifying objects of interest from image data, the system comprising:
a memory;
one or more processors; and
one or more programs, wherein the one or more programs are stored in the memory and configured to be executed by the one or more processors, the one or more programs when executed by the one or more processors cause the processor to:
receive a plurality of supporting evidence from one or more evidence sources;
identify an indicator from the plurality of supporting evidence that indicates an object of interest may be located in a particular geolocation at a particular time;
select one or more candidate images from a plurality of digital images based on the indicator;
segment one or more potential objects of interest from the one or more selected candidate images, wherein segmenting the one or more potential objects of interest from the one or more selected candidate images comprises applying one or more segmentation analytics to the one or more selected candidate images to identify the one or more potential objects of interest;
determine whether each of the one or more segmented potential objects of interest is an object of interest;
determine an object type for each identified object of interest; and
determine whether each identified object of interest is a specific known object of interest.

11. The system of claim 10, wherein determining whether each of the one or more segmented potential objects of interest is an object of interest comprises applying one or more object detection analytics comprising one or more object detection classifiers to the one or more selected candidate images.

12. The system of claim 11, wherein the one or more object detection analytics identify one or more environmental characteristics in the one or more selected candidate images, and determining whether each of the one or more segmented potential objects of interest is an object of interest comprises:
selecting one or more scene classifiers from a plurality of scene classifiers based on the identified one or more environmental characteristics; and
applying one or more scene analytics comprising the one or more selected scene classifiers to the one or more selected candidate images.

13. The system of claim 11, wherein determining the object type for each identified object of interest comprises:
selecting one or more object type classifiers from a plurality of object type classifiers; and
applying one or more object type analytics comprising the one or more selected object type classifiers to the one or more selected candidate images.

14. The system of claim 13, wherein the one or more object type classifiers are selected based on the results of applying the one or more object detection analytics.

15. The system of claim 13, wherein determining whether each identified object of interest is a specific known object of interest comprises:
selecting one or more known object classifiers from a plurality of known object classifiers; and
applying one or more known object analytics comprising the one or more selected known object classifiers to the one or more selected candidate images.

16. The system of claim 15, wherein the one or more known object classifiers are selected based on the results of applying the one or more object type analytics.

17. The system of claim 10, wherein the one or more programs when executed by the one or more processors cause the processor to generate assessment data based on the indicator and embedding the assessment data as metadata in one or more selected candidate images.

18. The system of claim 10, the one or more programs when executed by the one or more processors cause the processor to determine one or more status indicators about the one or more identified objects of interest and embedding the one or more status indicators as metadata that accompanies the one or more selected candidate images.

19. A computer-readable storage medium storing one or more programs for identifying objects of interest from image data, the one or more programs comprising instructions which, when executed by an electronic device with a display and a user input interface, cause the device to:
identify an indicator from the plurality of supporting evidence that indicates an object of interest may be located in a particular geolocation at a particular time;
select one or more candidate images from a plurality of digital images based on the indicator;
segment one or more potential objects of interest from the one or more selected candidate images, wherein segmenting the one or more potential objects of interest from the one or more selected candidate images comprises applying one or more segmentation analytics to the one or more selected candidate images to identify the one or more potential objects of interest;
determine whether each of the one or more segmented potential objects of interest is an object of interest;
determine an object type for each identified object of interest; and
determine whether each identified object of interest is a specific known object of interest.

20. The computer-readable storage medium of claim 19, wherein determining whether each of the one or more segmented potential objects of interest is an object of interest comprises applying one or more object detection analytics comprising one or more object detection classifiers to the one or more selected candidate images.

21. The computer-readable storage medium of claim 20, wherein the one or more object detection analytics identify one or more environmental characteristics in the one or more selected candidate images, and determining whether each of the one or more segmented potential objects of interest is an object of interest comprises:
selecting one or more scene classifiers from a plurality of scene classifiers based on the identified one or more environmental characteristics; and
applying one or more scene analytics comprising the one or more selected scene classifiers to the one or more selected candidate images.

22. The computer-readable storage medium of claim 20, wherein determining the object type for each identified object of interest comprises:
selecting one or more object type classifiers from a plurality of object type classifiers; and
applying one or more object type analytics comprising the one or more selected object type classifiers to the one or more selected candidate images.

23. The computer-readable storage medium of claim 22, wherein the one or more object type classifiers are selected based on the results of applying the one or more object detection analytics.

24. The computer-readable storage medium of claim 22, wherein determining whether each identified object of interest is a specific known object of interest comprises:
selecting one or more known object classifiers from a plurality of known object classifiers; and
applying one or more known object analytics comprising the one or more selected known object classifiers to the one or more selected candidate images.

25. The computer-readable storage medium of claim 24, wherein the one or more known object classifiers are selected based on the results of applying the one or more object type analytics.

26. The computer-readable storage medium of claim 19, the one or more programs comprising instructions which, when executed by an electronic device with a display and a user input interface, cause the device to generate assessment data based on the indicator and embedding the assessment data as metadata in one or more selected candidate images.

27. The computer-readable storage medium of claim 19, the one or more programs comprising instructions which, when executed by an electronic device with a display and a user input interface, cause the device to determine one or more status indicators about the one or more identified objects of interest and embedding the one or more status indicators as metadata that accompanies the one or more selected candidate images.
